(19) United States
(12) Patent Application Publication
(10) Pub. No.: US 2023/0059767 A1
(43) Pub. Date: Feb. 23, 2023

(54) PROGRAM, TERMINAL, SERVER, AND GAME SYSTEM

(71) Applicant: BANDAI CO., LTD., Tokyo (JP)

(72) Inventors: Hideto KOTANI, Tokyo (JP); Masahiko SAITO, Tokyo (JP)

(21) Appl. No.: 17/800,203

(22) PCT Filed: Feb. 17, 2021
(86) PCT No.: PCT/JP2021/005979

§ 371 Date: Aug. 16, 2022

(30) Foreign Application Priority Data
Feb. 17, 2020 (JP) 2020-023945

(51) Int. Cl. A63F 13/533; A63F 13/537; A63F 13/35

(52) U.S. Cl. CPC A63F 13/533; A63F 13/537; A63F 13/35; A63F 2300/308; A63F 2300/303; A63F 2300/5546

(57) ABSTRACT

The present invention enhances enjoyability of a user by performing a display processing in which reward information indicating that a reward is granted if a player at least plays a second battle consecutively after a first battle after a win or loss of the first battle has been determined.

### TECHNICAL FIELD

The present invention relates to a program, a terminal, a server and a game system.

### BACKGROUND ART

In recent years, games using a smartphone, a mobile phone or the like as a platform, are popular. For example, such a game assigns a virtual object such as a character, etc., to a user (for example, Patent Literature 1).

### PRIOR ART DOCUMENTS

### Patent Literature

Patent Literature 1:Japanese Patent Application Publication No. 2019-171015

### SUMMARY OF INVENTION

### Technical Problem

Such a conventional game calls for display of information, which enhances user's enjoyability. Accordingly, the present invention is made to address and resolve such a problem and to provide a display which enhances the user's enjoyability.

### Solution to Problem

As one of aspects of the present invention, a program causes a computer to perform a game by using a game element, and the program causes the computer to performs a display processing capable of displaying reward information indicating that there is a possibility that a reward is granted to a player if the player at least plays a second battle, which follows a first battle after a win or loss of the first battle played by the player is determined.

Another aspect of the present invention is a terminal, which performs a game by using a game element, and includes a display control device capable of displaying reward information indicating that there is a possibility that a reward is granted, if a player at least plays a second battle which follows a first battle after a win or loss of the first battle played by the player is determined.

Yet another aspect of the present invention is a server, which includes a presenting device capable of presenting, to a terminal of a player, reward information indicating that there is a possibility that a reward is granted, if a given condition is satisfied and the player at least plays a second battle which follows the first battle, after a win or loss of the first battle played by the player is determined. The server also includes a transmission device for transmitting data related to the reward to the terminal of the player, when the given condition is satisfied and the player at least plays the second battle which follows the first battle.

Further, another aspect of the present invention is a game system which includes; a device by which a player plays a battle by using a game element, and a presenting device capable of presenting reward information indicating that there is a possibility that a reward is granted, if a predetermined condition is satisfied and the player at least plays a second battle which follows the first battle, after a win or loss of the first battle played by the player is determined. The game system also includes a device, which acquires data related to the reward when the player at least plays the second battle follows the first battle.

### ADVANTAGEOUS EFFECTS OF INVENTION

According to the present application, information which enhances enjoyability of a user can be displayed.

### BRIEF DESCRIPTION OF DRAWINGS

FIG. 1 is a diagram illustrating one example of an overall configuration of a game system according to the present embodiment.

FIG. 2 is a diagram illustrating one example of device configuration of a smartphone, which is an example of a player terminal 1.

FIG. 3 is a diagram illustrating one example of a screen display shown on a display 11 of the player terminal 1 in a standby phase of a battle game or a card usage preparation phase thereof.

FIG. 4 is a diagram illustrating one example of an operation on the display 11 of the player terminal 1 in the standby phase of the battle game or the card usage preparation phase thereof.

FIG. 5 is a schematic diagram illustrating the player terminal 1.

FIG. 6 is a diagram illustrating one example of player data.

FIG. 7 is a diagram illustrating one example of card data.

FIG. 8 is a schematic diagram illustrating a game server 2.

FIG. 9 is a sequence diagram illustrating operations according to an embodiment of the present invention.

FIG. 10 is a flow chart illustrating reward information presenting processing.

FIG. 11 is a flow chart illustrating reward information grant processing.

FIG. 12 is a flow chart illustrating reward information display processing.

FIG. 13 is a flow chart illustrating reward acquisition processing.

FIG. 14 is a diagram illustrating one example of a display screen which displays details of reward information.

FIG. 15 is a diagram illustrating one example of a display screen which displays a reward acquired by a player.

### DESCRIPTION OF EMBODIMENTS

### System Overview

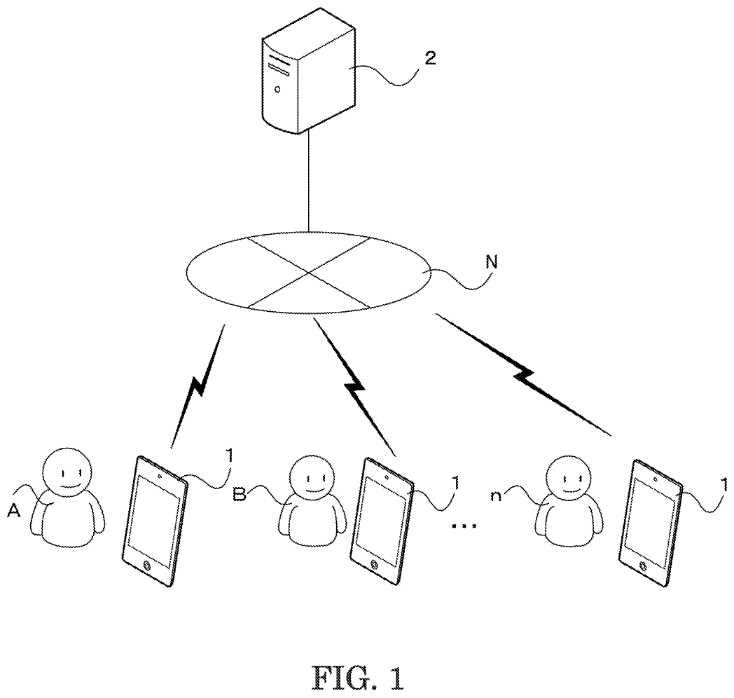

FIG. 1 is a diagram illustrating an example of an overall configuration of a game system according to the present invention. As illustrated in FIG. 1, the game system is configured to include player terminals 1, each of which is provided for one of game players A, B . . . , and n, (n represents a natural number). The game system is also configured by including a game server 2. The player terminals 1 and the game server 2 can be connected to a communication line N so as to communicate with each other.

The communication line N is a communication path capable of communicating data. That is, the communication line N includes a communication network, such as a telephone communication network, a cable network, internet, etc., in addition to a LAN established by a dedicated line (dedicated cable) for direct connection or an Ethernet (registered trademark) and the like. A communication of the communication line N may be achieved by any method either by wire or over the wireless.

The player terminal 1 is a computer capable of running game programs, and can be connected to the communication line N via a wireless communication base station or the like, and can perform data communication with the game server 2. The player terminal 1 may be a smartphone, a mobile phone, a portable game device, a stationary home game device, a business use game device, a personal computer, a tablet computer, a controller for a stationary home game device or the like. Basically, there are multiple player terminals 1, and are operated by respective players.

The game server 2 is a server system configured by including one or more server devices and memory devices or the like. The game server 2 provides various services for running a game according to the present invention. The game server 2 can perform data management necessary for running the game and deliver the game program and data necessary for performing the game at the player terminals 1 or the like.

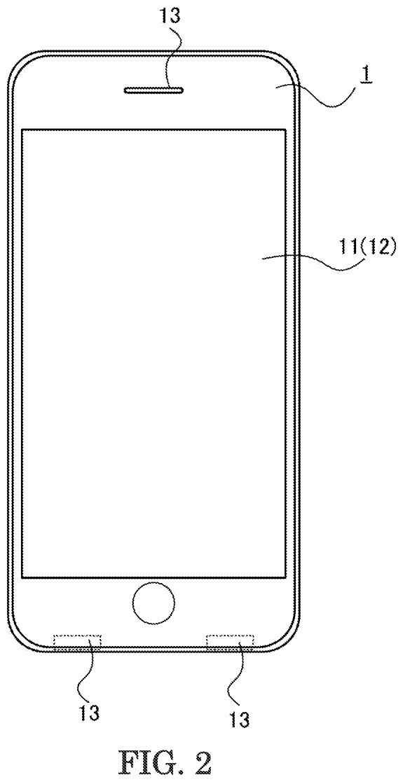

FIG. 2 is a diagram illustrating the device configuration of a smartphone, which is one example of the player terminal 1. As shown in FIG. 2, the player terminal 1 includes a display 11, a touch operation panel 12 integral with the display 11, and a speaker 13. Although not illustrated, the player terminal 1 also includes a control board, a built-in battery, and a power button, and a volume control button or the like.

On the control board, a microprocessor, such as a CPU, a GPU, a DSP, etc., various kinds of IC memories, such as an ASIC, a VRAM, a RAM, a ROM, or the like, a wireless communication module, which communicates wirelessly with a mobile phone base station or the like are mounted. Further, on the control board, a so-called VF circuit (interface circuit), such as a driver circuit for the touch operation panel 12, etc., is mounted. These elements mounted on the control board are electrically connected with one another via a bus circuit or the like, so that data may be read and written, and signals may be transmitted and received.

### Description of Game

To help understanding of the present invention, a game will be described. The game is described based on an example of a match-up (battle) game in which a first game element possessed by a player is used in the above-described game system.

Here, the first game element is a character represented by a form embodied in an image, such as a still image, a video image, etc., or as a virtual or substantial article or the like. As one example of the virtual or substantial article, a virtual card displayed on a computer or a substantial card and the like is exemplified. The first game element is used by a player (including a non-player operated by a computer) as a device for attacks or defenses in a battle of the game. Here, the article is not limited to such a card as long as it is an article, from which such a game element associated with the article can be identified. For example, the article may be a sculptural object, such as a figure having an appearance of the game element. In the following description, it is premised that, in the game to be performed, the first game element, which can appear when such a card is used, is a character whose action is controlled based on an operation of the player, and that a corresponding character design (an image exhibiting an exterior appearance of the character) is attached to the card. In addition, the card used to identify the game element in the game to be performed is not limited to such a card capable of specifying the game element, such as the character, etc. Such a card may, of course, be a card which can identify other game elements, such as items, effects for invoking an action, etc.

Further, a second game element different from the first game element is added to the match-up battle game to which the present invention is applied. Although the second game element is a certain character, it does not necessarily need to be associated with a virtual or substantial article.

The second game element has a nature of providing the player with operation assistance information related to a progress of the game at least in an operable phase during which the player can perform an operation in a battle in the game. In other words, the second game element provides the operation assistance information autonomously or voluntarily in the game, unlike the first game element in which an action is controlled based on an operation of the player.

The operation assistance information provided by the second game element may be any type as long as it relates to the game. For example, explanatory information necessary for the game progression, such as explanation about operation methods, operation instructions, explanation of terminologies, etc.; information on selection or action of the first game element (advice information, such as card selection, cards of an opponent to be attacked, etc.,); and tactical information about strategies for winning the battle, such as information, which turns progress of the battle in a game in favor (advice information, such as presentation of a type of card, which provides advantageous effects to a win/loss in the game battle) or the like, is exemplified as the operation assistance information.

Such a second game element is obtained by selection from two or more second game elements. The second game element allows the first game element to be used in the game. Here, use of the first game element includes a selection of the first game element or a determination of an action of the character of the first game element in the game. In case where the first game elements are, for example, cards, the second game element autonomously or voluntarily (actively) selects a card or determines an action (behavior) of the character of the card in a battle of the game. In other words, as in a function of a non-player operated by a computer, the second game element performs an operation similar to selection of a first game element or determination of an action of a character of a card and the like, which is performed by the player. Here, although a conventional non-player is operated by the computer instead of a human player, the second game element exists separately and independently from the human player, and differs therefrom in that the second game element uses the first game elements possessed by the player. Further, unlike the conventional non-player, the player and the second game elements collectively form a group (a pair) and play against an opposing player.

Further, the second game element is called either a buddy or a codeman and has character information. The character information is composed of a degree of strength (a level) of the second game element in the game and attribute information (such as a gender, a personality, etc.,). The character information affects an autonomous or voluntary (active) action of the second game element (use of a first game element). In other words, the character information is an ability of the second game element, so that a difference in such ability makes a difference in the autonomous or voluntary (active) behavior of the second game element (use of the first game element). Then, the character information changes at a time when the second game element is selected and/or in accordance with the progress of the game.

The above-described autonomous or voluntary (active) action performed by the second game element is performed based on information provided by an AI function included in the game server 2. The AI function is obtained by performing machine learning which uses details of progress and battle results of many match-up (battle) games or the like, as training data. Although a deep learning, a reinforcement learning, or a combination of these learnings may be typical machine learning, it is not limited thereto.

Further, details of the autonomous or voluntary operation assistance information of the second game element or timing of provision thereof changes in accordance with the character information possessed by the second game element. The character information changes as the game proceeds. The character information can have two or more parameters. For example, in the present embodiment, the character information includes a parameter, which changes in accordance with an empirical value obtained by wins or loses of games (hereinafter referred to as a level); a parameter, which changes in accordance with a frequency of usage as to types of first game elements (hereinafter referred to as a card comprehension level); and a parameter, which changes in accordance with usage rates as to the types of the first game elements (hereinafter referred to as a personality). The character information also includes a parameter, which changes in accordance with a predetermined event (hereinafter referred to as a synchronization level).

Here, the level represents a basic level of the second game element and is increased in accordance with an empirical value gained by playing battles. Then, as the level increases, a thinking ability of the second game element can be increased. As the thinking ability increases, it is possible to provide the operation assistance information more appropriately in accordance with a situation of the game.

Here, the card comprehension level is a level of comprehension about the first game elements (a level of comprehension of effects etc. activated by a character of each card). Hence, as the card comprehension level increases, it is possible to provide the operation assistance information, which more appropriately notifies timing for using the first game elements (cards).

The personality represents an attribute of the second game element and varies in accordance with usage rates as to attributes of the first game elements (having an attribute depending on each character).

The synchronizing level increases when a predetermined event is achieved in the game. The predetermined event is either a login to the game or a second game element's action performed together with the player in the game. Due to a difference in the synchronization level, expression content of the operation assistance information and the like is different. For example, the higher the synchronization level, the more intimate the expression.

The game server 2 has two or more AI functions corresponding to the above-described character information. The AI functions can thus provide the operation assistance information in accordance with a level of the character information. That is, as the character information of the second game element becomes more detailed, the operation assistance information can be more appropriately provided.

### Outline of Game

An outline of a game will be described by using the display screen of the display 11 of the player terminal 1.

In the game according to the present embodiment, players use virtual game cards (hereinafter simply referred to as cards) as the first game elements (game objects). Two or more types of cards are prepared, and are distinguished from each other by combinations of abilities of characters which are associated with the respective cards and attributes of the cards etc. As the abilities of the characters, for example, an ability parameter value, such as a level, an attack power, and HP (hit point), etc., used in the match-up play (a battle) against an opponent, which is an enemy character controlled by a computer or another player, etc., is predetermined. The attribute of the card is defined by a color, such as red, blue, etc., and a numeral or the like, for example.

As to the cards, a minimum number of cards required in a battle is given when an account is registered, or the cards can be acquired during a game. Furthermore, the cards can be acquired by purchasing them as paid items or by a lottery called Gacha. In addition, such cards can be acquired by obtaining a substantial game card (hereinafter referred to as a “real card”) and completing a registration process to make the real card usable in a game. Specifically, when a player registers the real card, the player can acquire a card whose type is associated with the real card.

The player then creates a deck by selecting a predetermined number of cards (for example, 40 sheets of cards) from cards possessed by the player, and challenges to a battle using the deck. The player needs to organize the deck before starting the battle. The deck can be organized from a deck organization menu, which is presented as a result of touching one on the card menu on a home screen or the like. If the number of the owned cards allows, two or more decks can be formed and set up. In the battle using such a deck, a win or loss of the battle against an opponent is determined by using at least ability parameter values (character information of the first game element) defined in the cards forming the deck (deck cards) and setting values of card attributes.

When starting the game, the player completes registration of an account. The player selects a favorite second game element from two or more second game elements when the player registers the account.

When a battle is ready, the player selects a battle menu (by a touch operation) from the home screen displayed after a login, and starts the battle.

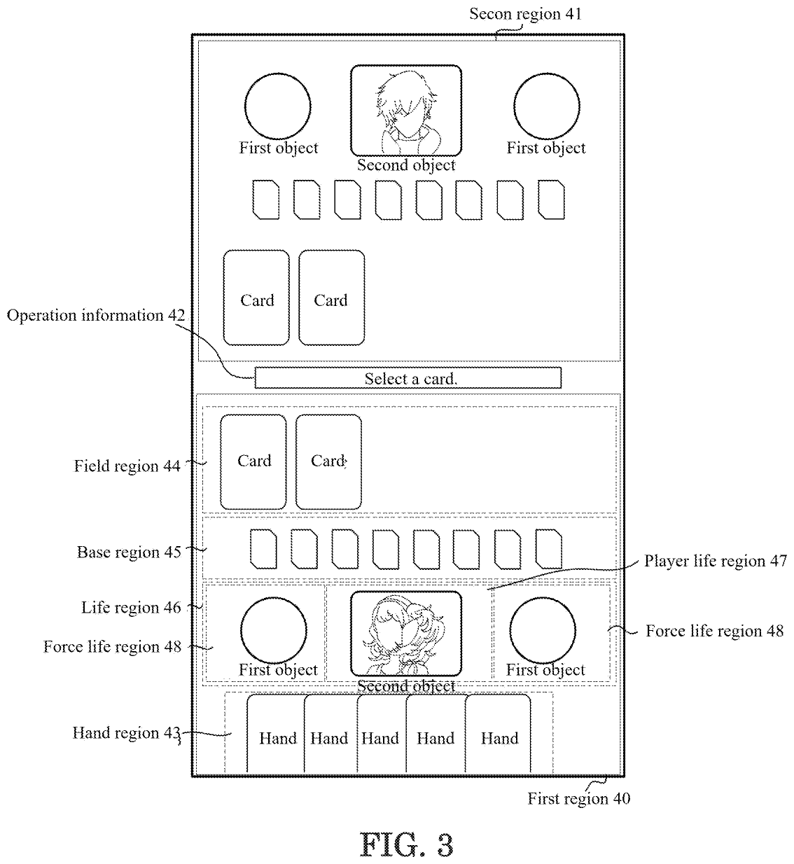

FIG. 3 is a diagram illustrating an example of a battle screen of a match-up (battle) game displayed on the display 11 of the player terminal 1. The screen of the display 11 includes a first player region 40 to which cards etc. of the own player are set. The screen of the display 11 also includes a second player region 41 to which cards etc. of an opposing player are set. Further, on a boundary between the first player region 40 and the second player region 41, operation information 42 related to an operation performed during the battle, such as “Select a card.” or “An opponent is acting” and the like is displayed.

Each of the first player region 40 and the second player region 41 includes a hand region 43, a field region 44, a base region 45 and a life region 46. The regions provided in the first player region 40 and the second player region 42 are located in linear symmetry across the operation information 42. In the hand region 43 included in each of the first player region 40 and the second player region 41, cards (hands) acquired from the own deck are arranged. Cards selected by the players from the hand region 43 and the base region 45 are respectively arranged in the field regions 44 of the first player region 40 and the second player region 41. The cards in each of the hand regions 43 can be placed in the field region 44 by consuming a prescribed cost. Placing a card in the field region 44 is also referred to as a summon of a character. A card arranged in each of the field regions 44 can invoke an action or an effect of the card. In the base region 45 of each of the first player region 40 and the second player region 41, cards and mana items to be spent as a cost for arranging the card in each of the field regions 44 are arranged. The life region 46 in each of the first player region 40 and the second player region 41 includes a player life region 47 as a region for the own player having a life (HP), and a force life region 48 as a region for a first object (force) also having a life. In the player life regions 47 of each of the first player region 40 and the second player region 41, a game object (second object) of the second game element corresponding to the own player and a value of the life possessed by the own player are displayed. In the force life region 48, a first object and a value of the life possessed by the first object, are displayed. The first object demonstrates a specific effect in the game.

The battle is started by selecting the battle menu from the home screen displayed after login to the game is performed (by a touch operation). Here, before starting the game, each of the players needs to complete the registration of the account and formation of the deck. The deck can be created from the deck organization menu, which is presented as a result of touching a card menu displayed on the home screen or the like.

A battle is constituted by a predetermined number of turns. The turns are composed of turns of the own player and those of the opposing player. A turn of the own player and that of the opponent player are performed alternately. Each of the turns includes two or more phases composed of a standby phase, a mana phase (a card usage preparation phase), and a main phase (a battle phase) or the like.

The standby phase comprises a step in which a card drawn from the deck is placed in the hand region 43 or the like.

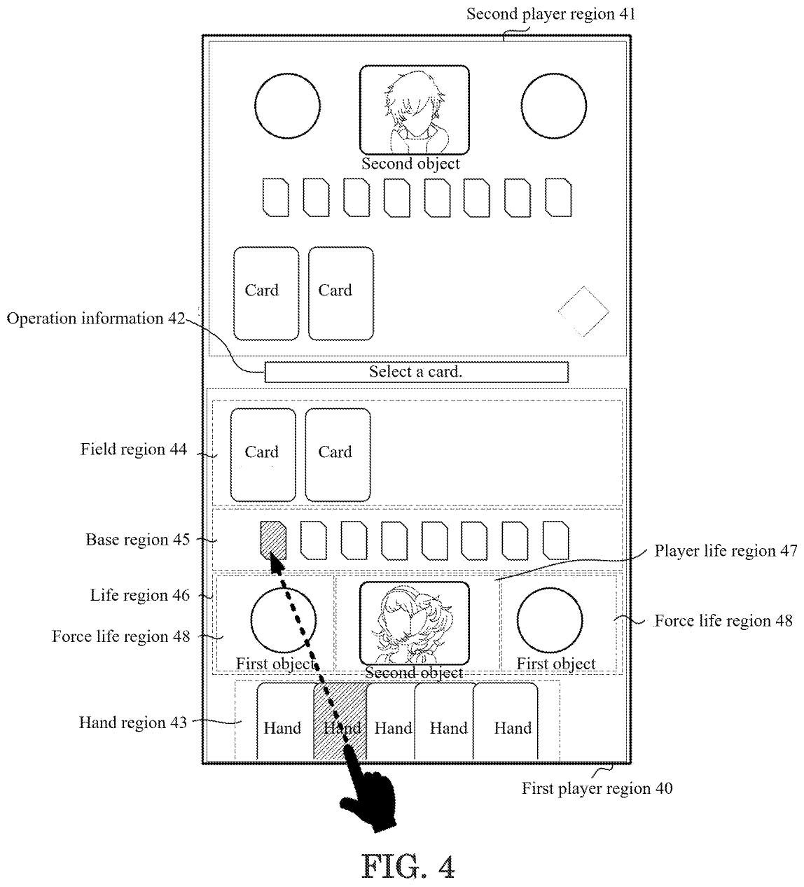

In the mana phase, the player can place cards or mana items in his or her base region 45. For example, as illustrated in FIG. 4, the player touches (selects) a card in the hand region 43 with a finger, drags and moves the card to the base region 45. Further, a mana item displayed at a predetermined position in the first player region 40 during the mana phase can also be placed in the base region 45 by touching (selecting) the mana item with a finger and dragging the mana item to the base region 45. These cards and mana items placed in the base region 45 can be consumed as a cost. Here, the player may terminate the mana phase without placing the card or the mana item in the base region 45.

In the main phase, the player can determine and perform an action of a card, such as a summon of a character, attacking an opponent (attack), activation of a card effect, and moving the card, etc.

In a battle, turns composed of the above-described series of phases are repeated alternatively between the own player and the opponent. Then, a win or loss is determined when either a life of any one of the players becomes 0 (zero) or the number of cards in the deck becomes 0 (zero).

According to the present invention, the reward information related to a reward, which a player can obtain, is displayed so as to enhance an enjoyability of the player in the game, in which battles are performed by operations, as described above.

### Configuration

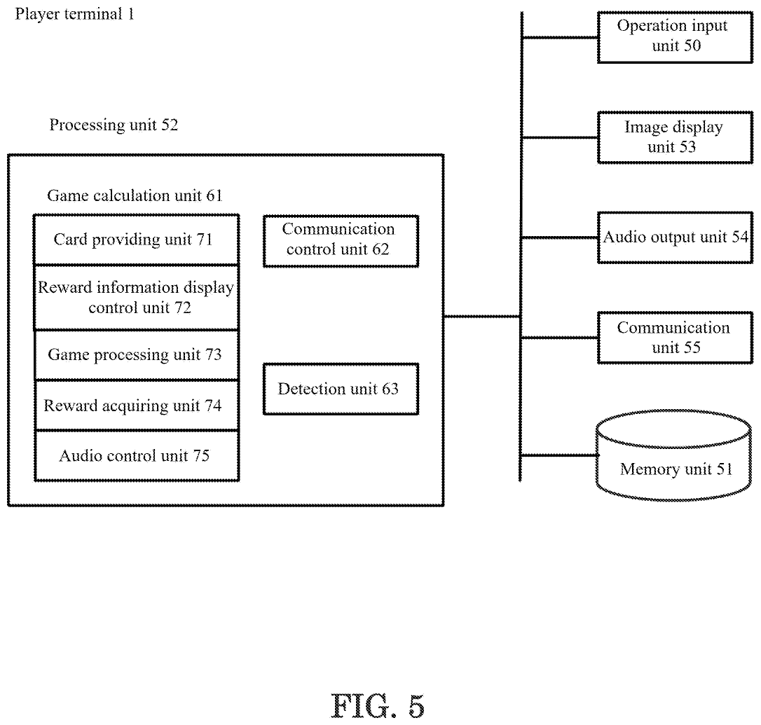

FIG. 5 is a block diagram illustrating one example of functional configuration of a player terminal 1. As illustrated in FIG. 5, the player terminal 1 includes an operation input unit 50, a memory unit 51, and a processing unit 52, an image display unit 53, an audio output unit 54, and a communication unit 55.

The operation input unit 50 is provided to input various operation inputs by the player, and outputs, to the processing unit 52, operation input signals, which correspond to the various operation inputs. Functions of the operation input unit 50 can be achieved by an element directly manipulated by a finger of the player, such as a touch operation pad, a home button, a button switch, a joystick, a trackball, etc. Functions of the operation input unit 50 can also be achieved by an element, which detects motion and posture, such as an acceleration sensor, an angular velocity sensor, an inclination sensor, and a geomagnetic sensor, etc. A touch operation panel 12 shown in FIG. 2 corresponds to this element.

In the memory unit 51, a program for operating the player terminal 1 and for realizing various functions of the player terminal 1 and data used during running of the program and the like, is stored in advance or such program and data is temporarily stored every time each processing is performed. The memory unit 51 can be realized, for example, by an IC memory, such as a RAM, a ROM, a flash memory, etc., a magnetic disk such as a hard disk, etc., or an optical disc, such as a CD-ROM, a DVD, etc.

In the memory unit 51, a system program and a game program is stored. The system program achieves basic functions of the player terminal 1 as a computer. The game program causes the processing unit 52 to function as a game calculating unit 61. This program is distributed from the game server 2 or another application distribution server or the like when the player completes registration of his or her account.

In the memory unit 51, player data and card data is also stored. In addition, model data, texture data, motion data, and effect data for displaying images of game elements, a background image of a game screen, sound data such as sound effects, etc. is timely distributed as necessary data for the game and is stored in the memory unit 51. Further, in the memory unit 51, data subject to a grant of a reward is also stored. For example, data of items possessed by the player, a currency used in the game, data of various tickets for events, and data of an empirical value, point data of various points used in the game and the like, is stored.

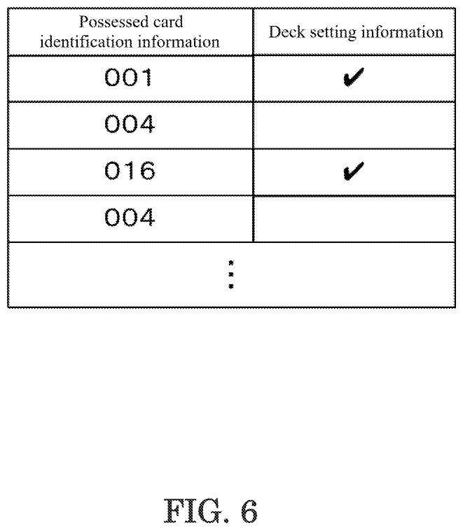

As the player data, basic user information, such as players' nicknames, etc., players' levels, and possessed card identification information, and deck setting information is stored. FIG. 6 is a diagram illustrating an example of the player data. The possessed card identification information is identification information of cards acquired by the player. When the player possesses two or more identical cards, the two or more cards with the same identification information are stored. In a battle performed by using such cards, a deck is formed by using a predetermined number of cards (for example 40 sheets of cards) from among the cards possessed by the player. Then, a battle play is performed against an opponent by using the deck. The deck setting information indicates whether the player sets corresponding cards into the deck. When the player sets a card to the deck, the deck setting information is checked (turned on).

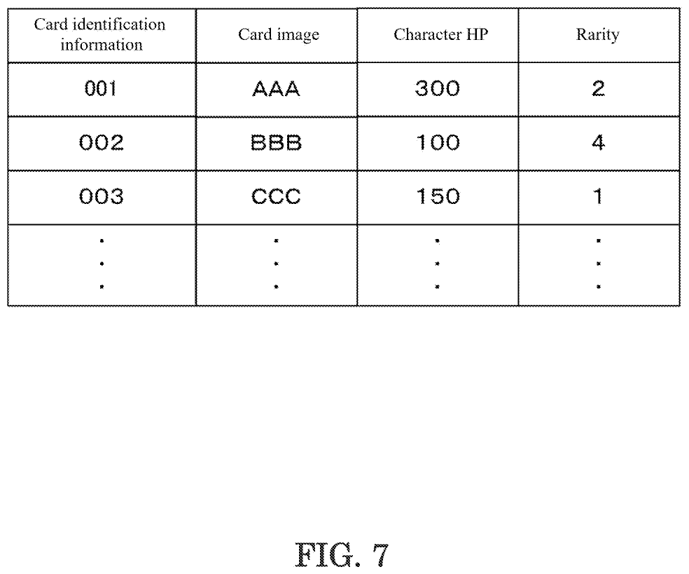

The card data is information related to all cards set in the game. FIG. 7 is a diagram illustrating one example of the card data. As the card data, identification information of each card, identification information of an image on the front side of each card, an ability of each character, and attribute of each card, which are associated with one another, are stored. FIG. 7 illustrates an example in which HP is stored as character ability information, and rarity is also stored as card attribute information.

The processing unit 52 integrally controls an operation of the player terminal 1 based on the program and data stored in the memory unit 51 and the operation input signals from the operation input unit 50 or the like. Functions of the processing unit 52 can be achieved, for example, by a microprocessor, such as a CPU, a GPU, etc., and electronic components including an ASIC and an IC memory or the like. The processing unit 52 includes a game calculating unit 61, a communication control unit 62, and a detection unit 63 as main functional units.

The game calculating unit 61 performs various game processing according to the present embodiment. The game calculating unit 61 includes a card providing unit 71, a display control unit 72, a game processing unit 73 a reward acquiring unit 74 and an audio control unit 75.

The card providing unit 71 performs processing related to provision of a card. A card is provided to the player when the player satisfies predetermined conditions for the card provision. The above-described conditions include payment of a price (by money, in-game currency, and points the player earns by participating in a drawing event conducted on the internet or the like), exchange for compensation obtained based on an action taken by the player in a game or outside the game, and registration of a user account or the like. When the player operates the touch operation panel 12 of the player terminal 2 and inputs a card provision request, the card providing unit 71 transmits the card provision request to the game server 3 via the communication unit 55. The card providing unit 71 receives identification information of the card transmitted from the game server 3 via the communication unit 55 when the card provision conditions are satisfied. The card providing unit 71 adds the received identification information of the card to user data stored in the memory unit 51.

The reward display control unit 72 controls display of images shown on the display 11 on the whole. The display control unit 72 displays reward information transmitted from the game server 2 on the display 11. The reward information indicates that there is a possibility that a reward is granted to the player when the player at least plays a second battle following a first battle, after a win or loss of the first battle has been determined. In other words, the reward information is information displayed during a period from after a decision of a win or loss of the current battle (after the battle ends) until the next battle, indicating that a reward may be granted if the player at least plays the next battle after the player has played the current battle. Specific content of the reward information and timing of displaying the reward information will be described later.

The game processing unit 73 generates card setting information based on a deck created by the player. Further, the game processing unit 73 executes battle processing. In the battle processing, the game processing unit 73 recognizes card selection or an action determined by the player who operates the player terminal 1 during his or her own turn, and then generates player action selection information for each turn. The game processing unit 73 receives a battle result for each turn, which is transmitted from the game server 2, and a win or loss result, which is transmitted after the end of the game. The game processing unit 73 controls a progress of the entire game.

The reward acquiring unit 74 determines as to whether data related to a reward has been received from the game server 2 within a predetermined time period after a win or loss of the second battle is determined. When the data related to the reward is received within the predetermined time, the reward acquiring unit 74 acquires the reward from the data related to the reward, and stores the data of the reward in the memory unit 51. Further, the reward acquiring unit 74 reflects the data to various data stored therein.

The audio control unit 75 generates audio signals of sound effects and a BGM related to the game; audio signals of audio information for operation assistance information; and audio signals for various operation sounds or the like, and then outputs these audio signals to the audio output unit 54. Functions of the audio control unit 74 can be achieved, for example, by a processor, such as a digital signal processor (DSP), an audio synthesis IC, etc., and an audio codec capable of reproducing an audio file, and the like.

The communication control unit 62 performs communication connection and data processing for data communication with the game server 2 via the communication unit 55 as described later.

The detection unit 63 detects if an input, which meets a preset condition, is inputted from the operation input unit 50. In the following description, depression in a given region on the display 11 is detected by the detection unit 63.

The image display unit 53 displays various game screens based on image signals input from the display control unit 71. Functions of the image display unit 53 can be achieved, for example, by a display device, such as a flat panel display, a cathode ray tube (CRT), a projector, a head-mounted display, etc. In FIG. 2, the image display unit 53 corresponds to the display 11.

The audio output unit 54 outputs sound effects or the like related to the game, based on audio signals input from the audio control unit 75. In FIG. 2, the audio output unit 54 corresponds to the speaker 13.

The communication unit 55 realizes communication by connecting with a communication line N. Functions of the communication unit 55 can be achieved, for example, by a wireless communication device, a modem, a TA (terminal adapter), a jack of a communication cable for wired communication, and a control circuit or the like.

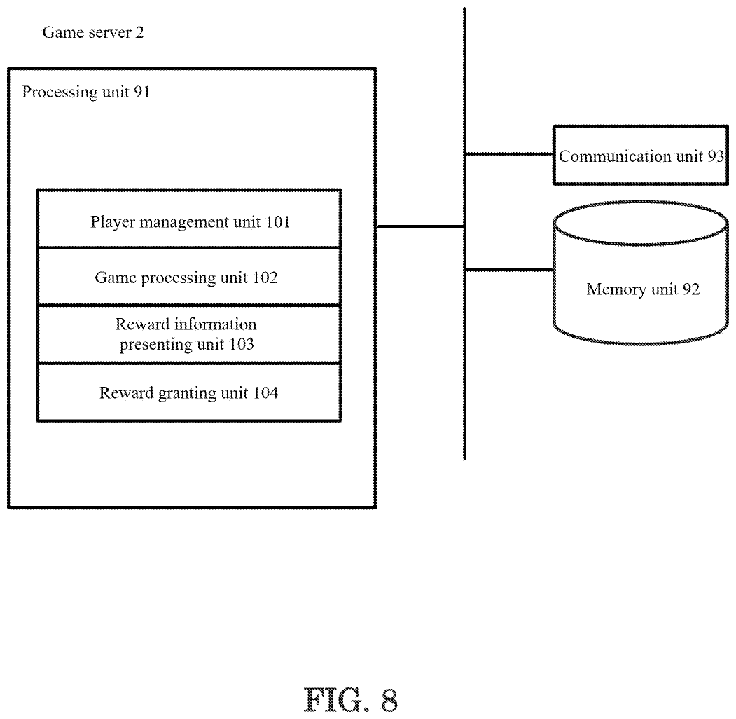

A configuration of the game server 2 will be described. FIG. 8 is a block diagram illustrating an example of a functional configuration of the game server 2.

The game server 2 includes a processing unit 91, a communication unit 93, and a memory unit 92.

The processing unit 91 includes a player management unit 101, a game processing unit 102, a reward information presenting unit 103, and a reward granting unit 104.

The player management unit 101 manages an account and a progress of a game etc. for each of connected player terminals 1 by using user information data.

The game processing unit 102 receives card setting information and information related to a game battle or the like from the player terminals 1. The game processing unit 102 then performs battle processing for each turn by using the card setting information, information related to the game battle, and card data. The game processing unit 102 then outputs a result of the battle for each turn.

When a win or loss of the first battle is determined, the reward information presenting unit 103 determines if conditions for presenting reward information (in other words, timing of displaying the reward information) are met. When it is determined that the conditions for presenting the reward information are met, the reward information presenting unit 103 transmits the reward information to the player terminal 1 via the communication unit 93.

The conditions on which the reward information presenting unit 103 presents the reward information can be exemplified as set forth below. Herein below, a battle in which a win or loss is determined, is referred to as a first battle.

(1) A result of the first battle is a win.
(2) A result of the first battle is a loss.
(3) The first battle is an initial battle performed within a predetermined period after a first login.
(4) As a result, based on a predetermined probability with which reward information is presented, it became necessary to present reward information. Here, the predetermined probability can be either a given constant probability or a variable probability where the probability varies. In the case of the given constant probability, it is determined with the constant probability whether to present reward information, regardless of conditions. For example, if the probability is fifty percent, the reward information is presented after the first battle at a rate of once in twice. By contrast, in the case of the variable probability, the probability varies in accordance with the number of players having logged therein when the player logs in to a game; the number of battles played by the player; the number of wins or losses of the battles played the player; and/or a level of the player or a class to which the player belongs. For example, where the probability varies in accordance with the number of players who have logged in to the game when the player logs in thereto, as the number of players is larger, the probability of presenting the reward information is made higher. Further, where the probability varies in accordance with the number of battles played by the player or the number of wins or losses of the battles played by the player, as the numbers thereof is higher, the probability of presenting the reward information is made higher. Where the probability varies in accordance with a level of the player or a class to which the player belongs, as the level of the player or the class, to which the player belongs, is higher, the probability of presenting the reward information is made higher, for example. However, these methods are just examples and the present invention is not limited thereto. Further, the variable probability may be established by combining these conditions. That is, at least any one of the conditions (1) to (4) is satisfactory, but can be combined with each other.

With regards to a time period during which the reward information is presented, as far as it is after a result of the first battle is displayed, there is no limitation to the time period. For example, the reward information can be displayed from after the end of the first battle until timing at which a second battle is started without logging out.

The reward information transmitted by the reward information presenting unit 103 includes at least one of a piece of information of conditions for granting a reward and a piece of information indicating the content of the reward. The conditions for granting the reward are exemplified as set below.

(1) When a player wins a second battle after the first battle, a reward shall be granted. Here, the second battle is the next battle, which is played by the player consecutively after the first battle without logging out.
(2) When the number of consecutive wins exceeds a predetermined number in battles including the second battle played after the first battle, a reward shall be granted.
(3) When the second battle is performed and the probability coincides with either a predetermined constant degree of probability or a degree of probability, which varies in accordance with a predetermined condition, a reward shall be granted.

The above-described conditions for granting the reward are just examples, and the present invention is not limited to them. For example, the above-described conditions for granting the reward can be combined with each other.

The information indicating the content of a reward may be at least one of information pieces related to a type of reward, a name of the reward, and the number of rewards, respectively. These pieces of information can be combined with each other. Information related to the type of reward is, for example, an in-game currency used in the game, a card used in the game, or an empirical value, which affects a level and/or a rank of the player. The information related to the name of the reward is, for example, a name of an in-game currency used in the game, a name of a card used in the game, or a name of an empirical value, which affects a level and/or a rank of the player. The information related to the number of rewards is, for example, the amount of in-game currency given to the player, the number of cards given to the player, the number of empirical values given to the player, or the like.

When a win or loss of the second battle is determined, the reward granting unit 104 selects a reward to be granted to the player, and generates data related to the reward. The reward granting unit 104 then transmits the data to the player terminal 1 via the communication unit 93.

The communication unit 93 achieves communication by connecting to the communication line N.

In the memory unit 92, a system program and a game program are stored. By the system program, basic functions of the game server 2, which serves as a computer, are realized. The game program causes the player management unit 101, the game processing unit 102, and the reward information presenting unit 103, and the reward granting unit 104 to function.

Further, the user information data and card data is stored in the memory unit 92.

The user information data is basic data of players who participate in the game, and the user information data is recorded for each player. The user information data includes identification information of cards possessed by a user. The card data is the same as the card data retained by the player terminals 1.

### Operation

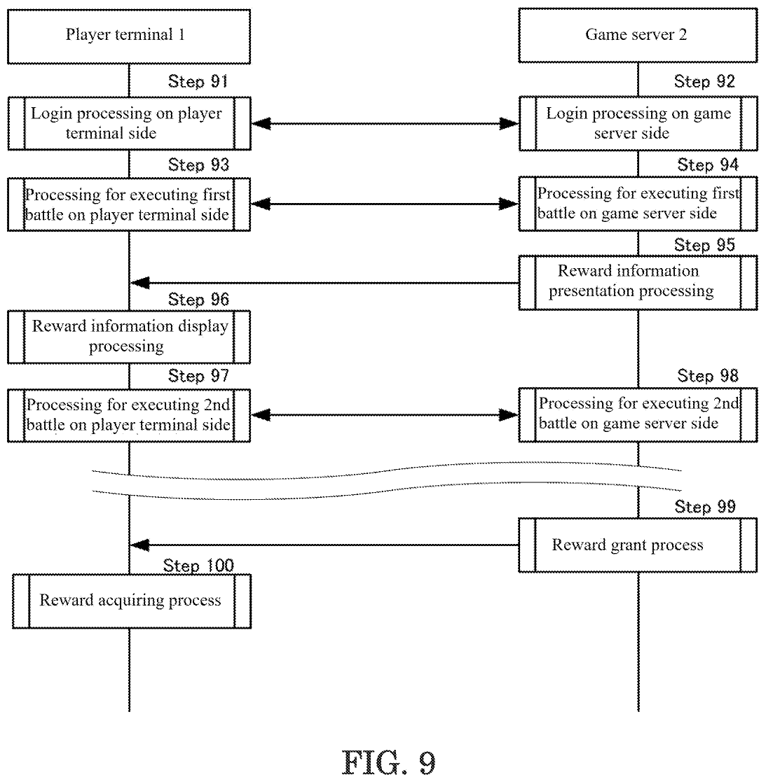

An operation according to the present embodiment will be described. FIG. 9 is a diagram illustrating a sequence of the operation according to the present embodiment.

The player terminal 1 performs login processing (in step S91). In the login processing performed at the player terminal 1, a player operates the player terminal 1 so that a login request is sent to the game server 2.

The game server 2 then performs a login processing (in step S92). In the login processing of the game server 2, when the game server 2 receives the login request from the player terminal 1, the game server 2 authenticates the player terminal 1 by using user information, and transmits a login permission to the player terminal 1.

The player terminal 1 performs a first battle execution processing for a first battle (in step S93). The game server 2 also performs a first battle execution processing for the first battle (in step S94). The first battle execution processing performed by the player terminal 1 and the game server 2 will be described. The player operates the player terminal 1 so as to select a card or determine an action for each turn. The game processing unit 73 of the player terminal 1 recognizes the selection or determination made by the player and generates player action selection information based thereon. The game processing unit 73 then transmits the player action selection information to the game server 2. The game processing unit 102 of the game server 2 performs the battle processing by using the player action selection information transmitted from the player terminal 1. The game processing unit 102 then transmits information of a result of the battle to the player terminal 1 for each turn. The display control unit 72 displays the battle result on the display 11 based on the battle result information transmitted from the game server 2 for each turn. When a win or loss is determined, the game server 2 sends the information of the battle result of the turn and winning or losing information of the battle to the player terminal 1. When the battle result information and the battle winning or losing information are transmitted, the display control unit 72 displays the battle result and the win or loss of the battle on the display 11 based on the battle result information and the battle winning or losing information.

When the win or loss of the first battle is determined and the first battle ends, the reward information presenting unit 103 of the game server 2 performs a reward information presenting processing (in step S95). In the reward information presentation processing, the reward information presenting unit 103 of the game server 2 determines if conditions for presenting reward information are met. If the conditions for presenting reward information are met, the reward information presenting unit 103 transmits reward information including conditions for granting the reward and details of the reward to the player terminal 1.

The reward display control unit 72 of the player terminal 1 performs a reward information display processing (in step S96). In the reward information display processing, the reward display control unit 72 of the player terminal 1 displays the reward information transmitted from the game server 2 on the display 11.

When the player does not perform a second battle, steps S91 to S96 are performed and the processing is then terminated. By contrast, when the player performs the second battle, the player terminal 1 performs an execution processing for performing the second battle (in step S97). The game server 2 also performs an execution processing for performing the second battle (in step S98). Details of the second battle execution processing performed by the player terminal 1 and the game server 2 are substantially the same as that of the first battle execution processing.

After battle execution processing for performing the second battle or battles after the second battle, the reward granting unit 104 of the game server 2 performs a reward grant processing (in step S99). In the reward grant processing (in step S99), based on results of the second battle and/or the battles played after the second battle, the reward granting unit 104 determines if the conditions for granting a reward are met. If the conditions are met, the reward granting unit 104 selects and transmits data related to the reward to the player terminal 1.

The player terminal 1 performs a reward reception processing (in step S100). The reward acquiring unit 74 receives data related to the reward transmitted from the game server 2 and acquires the reward from the received data related to the reward thereby reflecting (storing or updating) the reward in the memory unit 51.

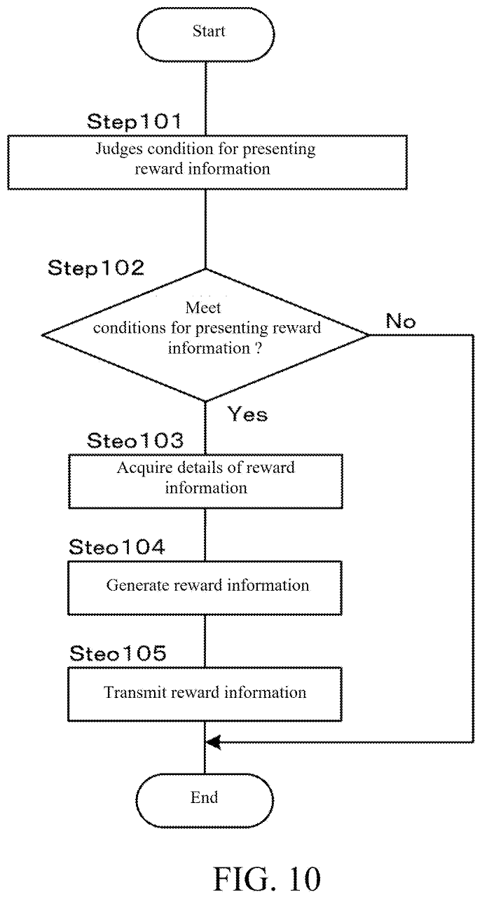

Next, a reward information presentation processing performed (in step S95) by the reward information presenting unit 103 included in the game server 2 will be described. FIG. 10 is a flow chart illustrating a reward information presentation processing.

The reward information presenting unit 103 determines if the conditions for presenting the reward information are met (in step S101). As the conditions for presenting the reward information, the conditions as described earlier may be used. Hence, any one or more of the above-described conditions are set in advance as the judgment conditions in the reward information presenting unit 103.

If it is determined that the conditions for presenting reward information are not met (NO, in step S102), the reward information presenting processing is terminated.

By contrast, when it is determined that the conditions for presenting the reward information are met (Yes, in step S102), the reward information presenting unit 103 acquires details of the reward information (in step S103). As the details of the reward information, the details as described earlier can be used. Hence, any one or more of the above-described details are set in advance as the reward information in the reward information presenting unit 103.

The reward information presenting unit 103 generates reward information based on the details of the acquired reward information (in step S104). The generated reward information is associated with the player to whom the reward information is presented.

Subsequently, the reward information presenting unit 103 transmits the generated reward information to the player terminal 1 (in step S105).

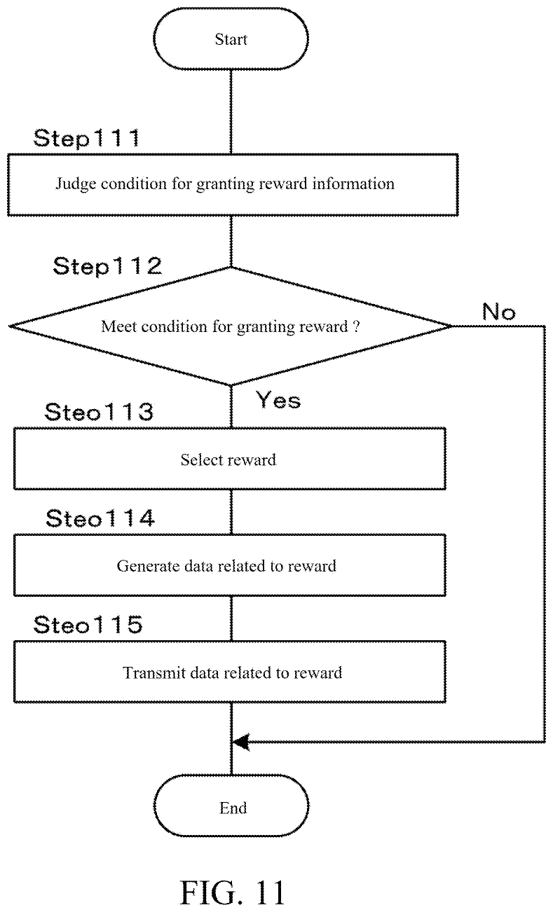

Next, reward information granting processing performed (in step S95) by the reward granting unit 104 in the game server 2 will be described. FIG. 11 is a flow chart illustrating a reward information granting processing.

The reward information granting unit 104 acquires the reward information associated with the player who is a reward granting determination target. The reward information granting unit 104 then determines if the conditions for granting a reward set in the reward information are met (in step S111). If it is determined that the conditions for granting reward are not met (No, in step S112), the reward granting process is terminated.

By contrast, if it is determined that the conditions for granting the reward are met (Yes, in step S112), the reward granting unit 104 selects the reward included in the reward information (in step S113).

The reward granting unit 104 then generates data related to the selected reward to be granted to the player (in step S114).

The reward granting unit 104 transmits the generated data related to the reward to the player terminal 1 (in step S115). At this moment, the reward granted to the player is also stored in the server if needed.

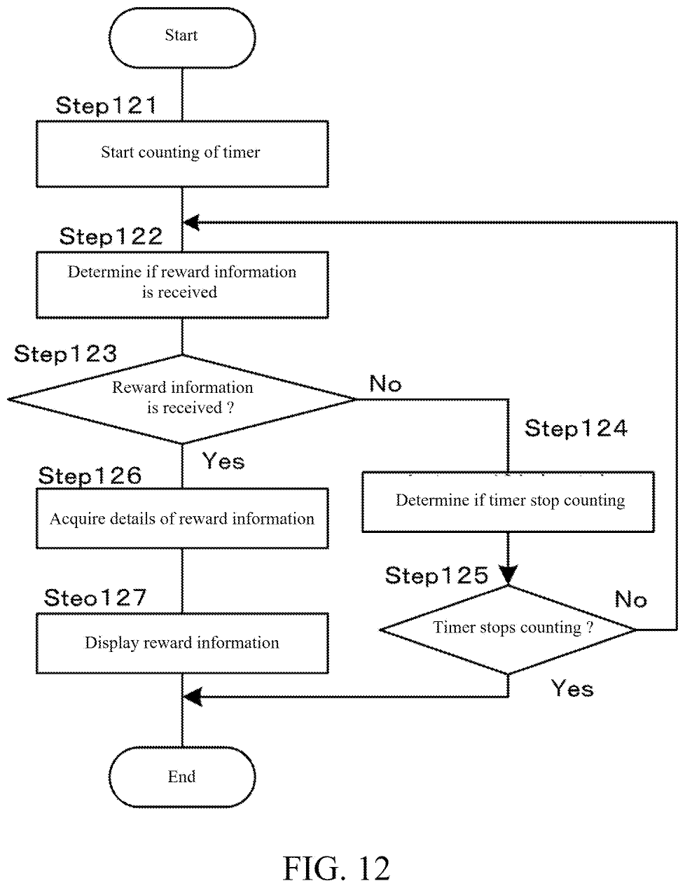

Next, the reward information display processing performed (in step S96) by the reward display control unit 72 in the player terminal 1 will be described. FIG. 12 is a flow chart illustrating the reward information display processing.

The reward display control unit 72 controls a timer to start counting (in step S121). The reward display control unit 72 determines if the reward information has been received from the game server 2 (in step S122).

When it is determined that the reward information has not been received (No, in step S123), it is further determined if a preset time has elapsed after the timer starts the counting (in step S124). When it is determined that the preset time has elapsed after the timer starts the counting (Yes, in step S125), the reward display control unit 72 terminates the reward information display processing. On the other hand, if it is determined that the preset time has not yet elapsed after the timer starts the counting (No, in step S125), the processing returns to Step S122.

When it is determined that the reward information has been received (Yes in step S123), the reward display control unit 72 acquires details of the reward information (in step S126). The reward display control unit 72 then displays the details of the acquired reward information on the display 11 (in step S127).

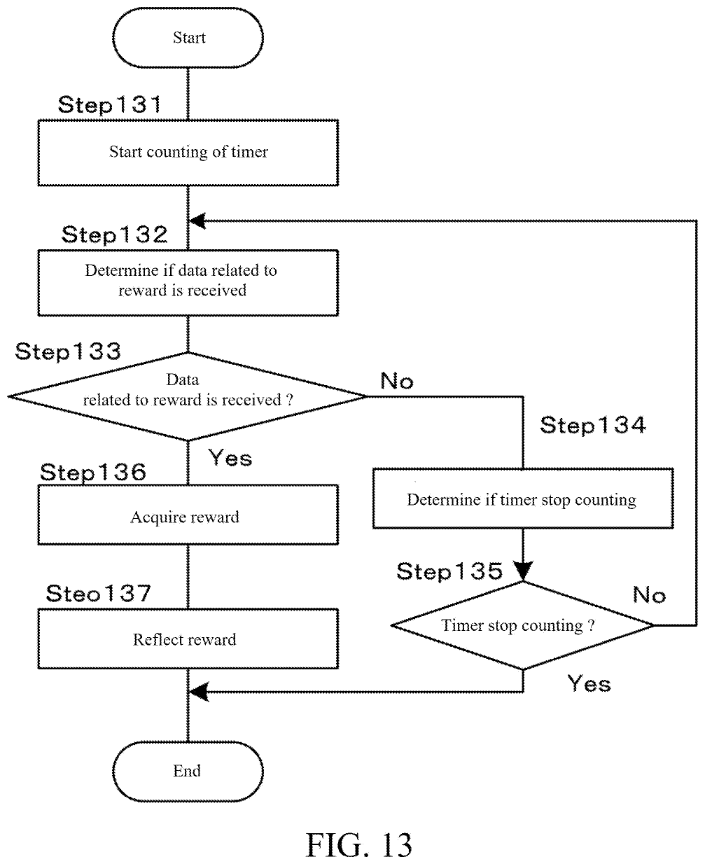

Next, reward acquisition processing performed (in step S100) by the reward acquiring unit 74 in the player terminal 1 will be described. FIG. 13 is a flow chart illustrating the reward acquisition processing.

The reward acquiring unit 74 causes the timer to start counting (in step S131). The reward acquiring unit 74 determines if data related to the reward has been received from the game server 2 (in step S132).

When it is determined that the data related to the reward has not been received (No, in step S133), it is determined if a preset time has elapsed after the timer starts the counting (in step S134). When it is determined that the preset time has elapsed after the timer starts the counting (Yes, in step S135), the reward acquiring unit 74 terminates the reward acquisition processing. On the other hand, if it is determined that the given time has not yet elapsed after the timer starts the counting (No, in step S135), the process returns to step S132.

When it is determined that the data related to the reward has been received (Yes, in step S133), the reward information acquiring unit 74 acquires the reward from the data related to the reward (in step S136). The reward acquiring unit 74 reflects the acquired reward to the user data (in step S137).

### Practical Examples

Specific examples according to the present invention will be described based on the conditions described below.
A condition for presenting reward information: A result of a first battle should be a win.
A condition for granting a reward: A reward is granted with a 50% wining probability when a win or loss of a second battle is determined (the second battle is completely performed to the end).
Details of a reward: The reward to be granted is a single card.

When a win or loss of the first battle is determined, the reward information presenting unit 103 in the game server 2 determines if a result of the battle is a win. When it is determined that the result of the first battle is the win, reward information is transmitted, wherein the reward information indicates that there is a 50 percent chance of obtaining one card if a following second battle is played until a win or loss of the second battle is determined.

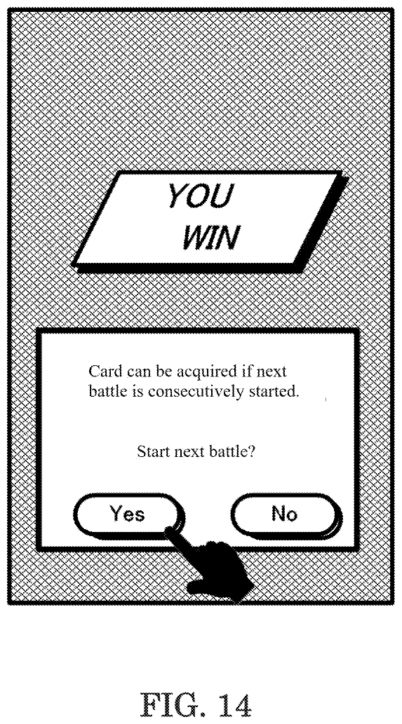

When the reward information is received, the display control unit 72 in the player terminal 1 displays details of the reward information on the display 11. FIG. 14 illustrates one example of a display screen displayed on the display 11.

The reward granting unit 104 in the game server 2 determines if a win or loss of the second battle has been determined. When it is determined that the win or loss of the second battle has been determined, the reward granting unit 104 transmits a piece of identification information of a card, which is a reward, to the player terminal 1.

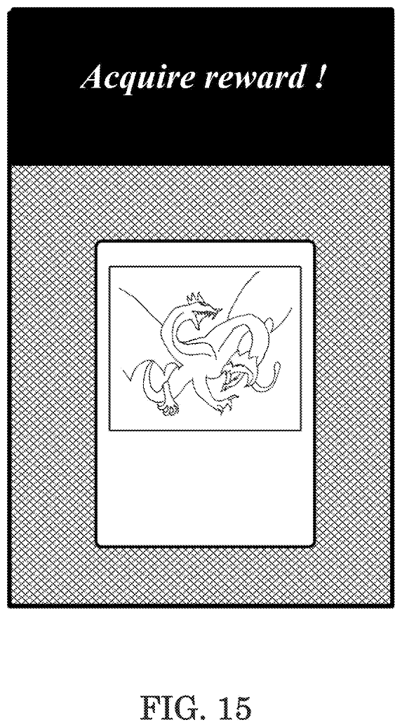

When the piece of the identification information of the card is received, the reward acquiring unit 74 stores the received piece of the identification information of the card in the memory unit 51 as player data. The reward acquiring unit 74 searches the card data stored the memory unit 51, for card identification information based on the received identification information. The reward acquiring unit 74 then reads identification information of an image of a front side of the card associated with the searched card identification information. The reward display control unit 72 reads the image of the front side of the card based on the identification information of the image on the front side of the card read by the reward acquiring unit 74. The reward display control unit 72 then displays the read image on the display 11. FIG. 15 illustrates an example of a display screen displayed on the display.

In the above-described embodiment, the game server 2 performs the reward information presenting processing (in step S95) and the reward granting processing (in step S99). However, the player terminal 1 may perform part or all of the reward information presenting process (in step S95) and the reward granting process (in step S99).

In the above description, the second battle is explained as a battle played without logging out after the end of the first battle. However, the present invention does not exclude the logging out.

As described heretofore, the preferred embodiment and specific examples have been described. However, the present invention is not necessarily limited to the above-described embodiments and specific examples, and can be modified and practiced in various manners within a technical idea of the present invention.

A part or all of the above-described embodiments can be also described as additional remarks set forth below. However, the present invention is not limited thereto.

(Additional Remark 1) A terminal performs a game by using a first game element. The terminal includes a memory, in which an executive instruction is stored, and a processor. Based on the executive instruction, the processor performs a display processing capable of displaying reward information indicating that there is a possibility that a reward is granted if the player at least plays the second battle subsequent to the first battle after a win or loss of the first battle has been determined.

(Additional Remark 2) A terminal includes a memory, in which an executive instruction is stored, and a processor. Based on the executive instruction, the processor performs a display processing capable of displaying reward information indicating that there is a possibility that a reward is granted if the player at least plays the second battle subsequent to the first battle, after a win or loss of the first battle has been determined.

(Additional Remark 3) A game management server is capable of communicating with a terminal, which performs a game using a game element. The game management server includes a memory, in which an executive instruction is stored, and a processor. Based on the executive instruction, the processor performs a presentation processing capable of presenting, to a terminal of the player, reward information indicating that there is a possibility that a reward is granted if the player satisfies a predetermined condition and at least plays the second battle subsequent to the first battle after a win or loss of the first battle has been determined, and the processor also performs a transmission processing for transmitting data related to a reward to the terminal of the player when the given condition is satisfied and the player at least plays the second battle consecutively after the first battle.

(Additional Remark 4) A program instructs a computer including a memory, in which an executive instruction is stored and a processor, to control the processor to perform a display processing capable of displaying reward information indicating that there is a possibility that a reward is granted if a player at least plays the second battle subsequent to the first battle after a win or loss of the first battle has been determined.

### REFERENCE SIGNS LIST

1 Player terminal

2 Game server

11 Display

12 Touch operation panel

13 Speaker

50 Operation input unit

51 memory unit

52 Processing unit

53 Image display unit

54 Audio output unit

55 Communication unit

61 Game calculating unit

62 Communication control unit

63 Detection unit

71 Card providing unit

72 Reward information display control unit

73 Game processing unit

74 Reward acquiring unit

75 Audio control unit

92 Memory unit

93 communication unit

101 Player management unit

102 Game processing unit

103 Reward information presenting unit

104 Reward granting unit

1. A program for causing a computer to perform a game by using a game element, wherein the program causing the computer to perform display processing capable of displaying reward information indicating that there is a possibility that a reward is granted if a player at least plays a second battle consecutively after a first battle after a win or loss of the first battle is determined.

2. The program according to claim 1, wherein in the display processing, the reward information is displayed on a condition that the first battle is won.

3. The program according to claim 1, wherein in the display processing, the reward information is displayed on a condition that the first battle is lost.

4. The program according to claim 1, wherein the reward information is presented with a given probability in the display processing.

5. The program according to claim 4, wherein the given probability is a predetermined constant probability.

6. The program according to claim 4, wherein the given probability is a variable probability.

7. The program according to claim 6, wherein the variable probability varies in accordance with at least one of:
the number of players who have logged therein when the player logs in;
the number of battles played by the player;
the number of wins or losses of the battles played by the player; and
a level of the player or a class to which the player belongs.

8. The program according to claim 1, wherein the reward information is displayed in the display processing after determination of a win or loss of a first battle, which is played after the player initially logs in within a predetermined time period.

9. The program according to claim 1, wherein the reward information is displayed for a predetermined period of time in the display processing after the win or loss of the first battle is determined.

10. The program according to claim 1, wherein the reward information includes information of a condition for granting the reward.

11. The program according to claim 10, wherein the condition for granting the reward is a win at the second battle.

12. The program according to claim 10, wherein the condition for granting the reward is the number of consecutive wins of consecutively winning at battles.

13. The program according to claim 10, wherein the condition for granting the reward is either a predetermined constant probability or a variable probability which varies in accordance with the condition.

14. The program according to claim 1, wherein the reward information relates to at least one of a type of the reward, a name of the reward, and the number of rewards.

15. The program according to claim 1, wherein the second battle is a battle played by the player consecutively after the first battle without logging out from the game.

16. (canceled)

17. A server comprising:
a presenting device to present, to a terminal of a player, reward information indicating that there is a possibility that a reward is granted if a given condition is satisfied and the player at least plays a second battle consecutively after a first battle, after a win or loss of the first battle has been determined; and
a transmission device to transmit data related to the reward to the terminal of the player, when the given condition is satisfied and the player at least plays the second battle consecutively after the first battle.

18. A game system comprising:
a battle performing device to perform a battle by using a game element;
a presenting device capable of presenting reward information indicating that there is a possibility that a reward is granted if a given condition is satisfied and the player at least plays a second battle consecutively after the first battle after a win or loss of a first battle is determined; and
a data acquiring device to acquire data related to the reward when the given condition is satisfied and the player at least plays the second battle consecutively after the first battle.
